(19) United States
(12) Patent Application Publication
(10) Pub. No.: US 2026/0282042 A1
(43) Pub. Date: Sep. 17, 2026

(54) TERMINAL DEVICE AND METHOD FOR DESTINATION SELECTION FOR SIDELINK TRANSMISSION

(71) Applicant: LENOVO (BEIJING) LIMITED, Beijing (CN)

(72) Inventors: Jing HAN, Beijing (CN); Ran YUE, Beijing (CN); Lianhai WU, Beijing (CN); Jie HU, Beijing (CN); Haiming WANG, Beijing (CN)

(21) Appl. No.: 19/168,591

(22) PCT Filed: Mar. 31, 2023
(86) PCT No.: PCT/CN2023/085746

§ 371 Date: Sep. 24, 2025

(51) Int. Cl. H04W 72/25; H04W 74/08

(52) U.S. Cl. CPC H04W 72/25; H04W 74/0866

(57) ABSTRACT

Embodiments of the present disclosure relate to a terminal device and a method for destination selection for sidelink transmission. A terminal device receives, via the transceiver, channel occupancy time (COT) sharing information. The terminal device determines whether there is at least one destination fulfilling a COT requirement associated with the COT sharing information among one or more destinations to which the terminal device has data to transmit. The terminal device selects, from the one or more destinations, a destination for a sidelink transmission based on a result of the determination. In this way, the reliability and efficiency of sidelink communication may be improved

### FIELD

Embodiments of the present disclosure generally relate to the field of communication, and in particular to a terminal device, a method, and a non-transitory computer readable medium for destination selection for sidelink transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). To meet the growing demands for expanded mobile broadband connectivity, the New Radio (NR) is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. In NR on Unlicensed band (NR-U), to co-exist with other wireless technology on unlicensed band e.g. Wi-Fi system, a Listen-Before-Talk (LBT) procedure may be performed on a scheduled or selected resource before each transmission to occupy the channel.

Sidelink (SL) transmissions may also operate on unlicensed bands. The LBT technique in NR-U may be introduced for the SL transmission to co-exist with other wireless systems on the unlicensed bands. If a type-1 LBT procedure succeeds, the sidelink equipment (UE) can access the channel and perform transmission. Furthermore, the sidelink UE can occupy the channel for a duration, which is called a channel occupied time (COT). Enhancements on transmissions for SL on Unlicensed band (SL-U) are still needed.

### SUMMARY

In general, embodiments of the present disclosure provide a solution for destination selection for a sidelink transmission in an unlicensed band.

In a first aspect, there is provided a terminal device. The terminal device comprises a processor and a transceiver coupled to the processor. The processor is configured to receive, via the transceiver, channel occupancy time (COT) sharing information; determine whether there is at least one destination fulfilling a COT requirement associated with the COT sharing information among one or more destinations to which the terminal device has data to transmit; and select, from the one or more destinations, a destination for a sidelink transmission based on a result of the determination.

In a second aspect, there is provided a method performed by a terminal device. The method comprises receiving channel occupancy time (COT) sharing information; determining whether there is at least one destination fulfilling a COT requirement associated with the COT sharing information among one or more destinations to which the terminal device has data to transmit; and selecting, from the one or more destinations, a destination for a sidelink transmission based on a result of the determination.

In a third aspect, there is provided a non-transitory computer readable medium. The non-transitory computer readable medium having program instructions stored thereon. The program instructions, when executed by an apparatus, causing the apparatus at least to: receive channel occupancy time (COT) sharing information; determine whether there is at least one destination fulfilling a COT requirement associated with the COT sharing information among one or more destinations to which the terminal device has data to transmit; and select, from the one or more destinations, a destination for a sidelink transmission based on a result of the determination.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates a schematic diagram of a communication environment in which some embodiments of the present disclosure can be implemented;

FIG. 2 illustrates a flowchart of an example method for destination selection in accordance with some embodiments of the present disclosure;

FIG. 3 illustrates an example block scheme for destination selection in accordance with some embodiments of the present disclosure; and

FIG. 4 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term: “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

To expand the applicability of destination selection in sidelink on unlicensed band to commercial use cases, one of identified key requirement is to increase the data rate. SL-U may be supported to fulfill the requirement. In addition, with the support of unlicensed spectrum, destination selection in SL-U will be in a better position to be implemented in commercial devices since utilization of the Intelligent Transport System (ITS) band is limited to ITS safety related applications.

For study of SL-U, one objective is the channel access mechanism, which is as following:

| - | Channel access mechanisms from NR-U shall be reused for sidelink unlicensed | |
|---|---|---|
| | operation | |
| | - | Assess the applicability of sidelink resource reservation from Rel-16/Rel-17 to |
| | | sidelink unlicensed operation within the boundaries of unlicensed channel |
| | | access mechanism and operation |

| | |
|---|---|
| -□ | No specific enhancements for Rel-17 resource allocation mechanisms |
| -□ | If the existing NR-U channel access framework does not support the |
| | required SL-U functionality, WGs will make appropriate |
| | recommendations for RAN approval. |

Before commencing sidelink transmissions over a shared spectrum or unlicensed spectrum, the sidelink UE may contend for channel access in the spectrum, for example, via CCA and/or LBT procedures. If a type-1 LBT procedure succeeds, the SL UE can occupy the channel for a COT. For example, a first UE may contend for a COT in in an unlicensed band for sidelink communication by performing a LBT procedure. After winning the contention, the first UE may transmit a sidelink data via a physical sidelink shared channel (PSSCH) and/or sidelink control information (SCI) via a physical sidelink control channel (PSCCH) to a second UE.

There are two resource allocation modes for transmissions in SL-U, i.e., a dynamic scheduling mode and an autonomous selection mode. In the dynamic scheduling mode, the network device dynamically allocates transmission resources to the SL UE according to the buffered data report of the SL UE. In the autonomous selection mode, the SL UE randomly selects the transmission resources from the resource pool broadcast or pre-configured by the network device.

A SL UE may perform multiplexing and assembly for a Medium Access Control Packet Data Unit (MAC PDU) that is to be transmitted in a selected resource in a sidelink unlicensed band. Since each MAC PDU can only be sent to one destination, the SL UE may perform a Logical Channel Prioritization (LCP) procedure during the multiplexing and assembly so as to select a target destination and corresponding logical channel(s) that will be multiplexed into the MAC PDU.

The legacy-LCP procedure is defined according to 5.22.1.4.1.2 in TS 38.321 which is shown as follows:

5.22.1.4.1.2 Selection of logical channels

The MAC entity shall for each SCI corresponding to a new transmission:

| 1> | if sl-BWP-DiscPoolConfig or sl-BWP-DiscPoolConfigCommon is configured | | | |
|---|---|---|---|---|
| | according to TS 38.331 [5]: | | | |
| | 2> | if the new transmission is associated to a sidelink grant in sl-DiscTxPoolSelected | | |
| | | or sl-DiscTxPoolScheduling configured in sl-BWP-DiscPoolConfig or | | |
| | | sl-BWP-DiscPoolConfigCommon: | | |
| | | 3> | select a Destination associated with NR sidelink discovery as specified in TS | |
| | | | 23.304 [26], that is in the SL Active time for the SL transmission occasion if | |
| | | | SL DRX is applied for the destination, and among the logical channels that | |
| | | | satisfy all the following conditions for the SL grant associated to the SCI: | |
| | | | 4> | SL data for NR sidelink discovery is available for transmission; and |
| | | | 4> | SBj > 0, in case there is any logical channel having SBj > 0; and |
| | | | 4> | sl-configuredGrantType1Allowed, if configured, is set to true in case the SL |
| | | | | grant is a Configured Grant Type 1; and |
| | | | 4> | sl-AllowedCG-List, if configured, includes the configured grant index |
| | | | | associated to the SL grant. |
| | 2> | else: | | |
| | | 3> | select a Destination associated to one of unicast, groupcast and broadcast | |
| | | | (excluding the Destination(s) associated with NR sidelink discovery as | |
| | | | specified in TS 23.304 [26]), that is in the SL Active time for the SL | |
| | | | transmission occasion if SL DRX is applied for the destination, and having at | |
| | | | least one of the MAC CE and the logical channel with the highest priority, | |
| | | | among the logical channels that satisfy all the following conditions and MAC | |
| | | | CE(s), if any, for the SL grant associated to the SCI: | |
| | | | 4> | SL data for NR sidelink communication is available for transmission; and |
| | | | 4> | SBj > 0, in case there is any logical channel having SBj > 0; and |
| | | | 4> | sl-configuredGrantType1Allowed, if configured, is set to true in case the SL |
| | | | | grant is a Configured Grant Type 1; and |
| | | | 4> | sl-AllowedCG-List, if configured, includes the configured grant index |
| | | | | associated to the SL grant; and |
| | | | 4> | sl-HARQ-FeedbackEnabled is set to disabled, if PSFCH is not configured |
| | | | | for the SL grant associated to the SCI. |
| 1> | else: | | | |
| | 2> | select a Destination associated to one of unicast, groupcast and broadcast, that is | | |
| | | in the SL Active time for the SL transmission occasion if SL DRX is applied for | | |
| | | the destination, and having at least one of the MAC CE and the logical channel | | |
| | | with the highest priority, among the logical channels that satisfy all the following | | |
| | | conditions and MAC CE(s), if any, for the SL grant associated to the SCI: | | |
| | | 3> | SL data is available for transmission; and | |
| | | 3> | SBj > 0, in case there is any logical channel having SBj > 0; and | |
| | | 3> | sl-configuredGrantType1Allowed, if configured, is set to true in case the SL | |
| | | | grant is a Configured Grant Type 1; and | |
| | | 3> | sl-AllowedCG-List, if configured, includes the configured grant index | |
| | | | associated to the SL grant; and | |
| | | 3> | sl-HARQ-FeedbackEnabled is set to disabled, if PSFCH is not configured for | |
| | | | the SL grant associated to the SCI. | |
| NOTE 1: | | | If multiple Destinations have the logical channels satisfying all conditions | |
| | | | above with the same highest priority or if multiple Destinations have either the | |
| | | | MAC CE and/or the logical channels satisfying all conditions above with the | |
| | | | same priority as the MAC CE, which Destination is selected among them is up | |
| | | | to UE implementation. | |
| 1> | select the logical channels satisfying all the following conditions among the logical | | | |
| | channels belonging to the selected Destination: | | | |
| | 2> | SL data is available for transmission; and | | |
| | 2> | sl-configuredGrantType1Allowed, if configured, is set to true in case the SL grant | | |
| | | is a Configured Grant Type 1; and. | | |
| | 2> | sl-AllowedCG-List, if configured, includes the configured grant index associated | | |
| | | to the SL grant; and | | |
| | 2> | sl-HARQ-FeedbackEnabled is set to the value that satisfies the following | | |
| | | conditions: | | |
| | | 3> | if PSFCH is configured for the sidelink grant associated to the SCI and the UE | |
| | | | is capable of PSFCH reception: | |
| | | | 4> | sl-HARQ-FeedbackEnabled is set to enabled, if |
| | | | | sl-HARQ-FeedbackEnabled is set to enabled for the highest priority |
| | | | | logical channel satisfying the above conditions; or |
| | | | 4> | sl-HARQ-FeedbackEnabled is set to disabled, if |
| | | | | sl-HARQ-FeedbackEnabled is set to disabled for the highest priority |
| | | | | logical channel satisfying the above conditions. |
| | | 3> | else: | |
| | | | 4> | sl-HARQ-FeedbackEnabled is set to disabled. |
| NOTE 2: | | | | HARQ feedback enabled/disabled indicator is set to disabled for the |

```
  transmission of a MAC PDU only carrying CSI reporting MAC CE or Sidelink
  DRX Command MAC CE or Sidelink Inter-UE Coordination Request MAC CE
  or Sidelink Inter-UE Coordination Information MAC CE.
```

Currently in 3GPP discussion, it is proposed that the COT initiated by a SL UE can be shared with other SL UE for a sidelink transmission in an unlicensed band. To fulfill the regulation, only when the receiver of a sidelink transmission is the initiating UE, i.e., the sidelink transmission is to be transmitted to the UE that initiated the COT, the sidelink transmission can be performed in the COT by the corresponding SL UE, which may be called a responding UE.

Before the LCP procedure, a physical layer of the SL UE may indicate the available COT duration and corresponding COT sharing information that may be used by the SL UE. Each COT duration can be used under corresponding restrictions of the destination identifier (ID) and channel access priority class (CAPC) priority. For example, only transmissions to those destinations with destination ID(s) in the COT sharing information can be allowed to use the COT, and only those logical channels, of which the CAPC priorities are equal or higher than the CAPC priority in the COT sharing information, can be selected to use the COT.

It has been agreed in TS 38.321 of the 3GPP RAN2 #121 meeting as follows:

Agreements on SL LCP and COT

| | |
|---|---|
| 1: | UE can select 1/ either to do a changed-LCP, in order to satisfy the COT |
| | requirement, and to do the type-2 LBT (How to do the LCP can be decided after |
| | RAN1 agreement) 2/ or to do a legacy-LCP, e.g. using type-1, type-2 LBT. |

However, conditions for UE to choose either LCP solution are still not clear, e.g., under which conditions the UE should perform the changed LCP procedure based on the COT sharing information. In addition, further studies are needed regarding to assistance information from the responding UE to the initiating UE for COT sharing.

In view of the above discussions, embodiments of the present disclosure provide a solution for destination selection for sidelink transmission. In one aspect of the solution of the present disclosure, a terminal device receives channel occupancy time (COT) sharing information. The terminal device determines whether there is at least one destination fulfilling a COT requirement associated with the COT sharing information among one or more destinations to which the terminal device has data to transmit. Based on a result of the determination, the terminal device selects a destination for a sidelink transmission from the one or more destinations. Through the proposed solution, the terminal device may be able to determine whether to perform the changed LCP procedure based on the COT sharing information or to perform the legacy LCP procedure. Thus, the reliability and efficiency of sidelink communication may be improved. Principles and implementations of embodiments of the present disclosure will be described in detail below with reference to the figures.

### Example Embodiment

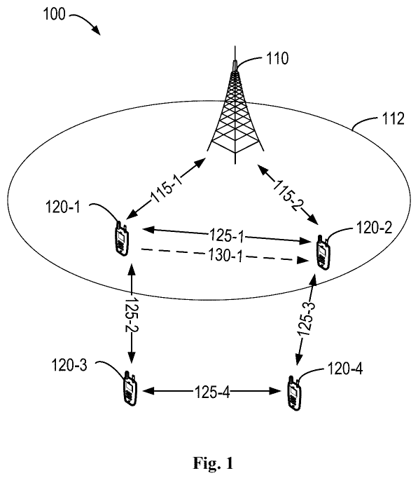

FIG. 1 illustrates a schematic diagram of a communication environment 100 in which some embodiments of the present disclosure can be implemented. As shown in FIG. 1, the communication environment 100, which may also be referred to as a communication network 100 or a communication system 100, includes a network device 110, a terminal device 120-1, a terminal device 120-2, a terminal device 120-3 and a terminal device 120-4 (collectively referred to as terminal devices 120).

The network device 110 manages a cell 112 and serves the terminal device 120-1 and the terminal device 120-2 in the cell 112. To transmit data and/or control information, the terminal device 120-1 and the terminal device 120-2 can perform communications with the network device 110, respectively. In particular, as illustrated in the exemplary scenario of FIG. 1, the terminal device 120-1 may communicate with the network device 110 via a communication link 115-1, and the terminal device 120-2 may communicate with the network device 110 via a communication channel 115-2. For transmissions from the network device 110 to the terminal device 120-1 or 120-2, the communication link 115-1 or 115-2 may be referred to as a downlink, whereas for transmissions from the terminal device 120-1 or 120-2 to the network device 110, the communication link 115-1 or 115-2 may alternatively be referred to as an uplink.

In addition to the communication links 115-1 and 115-2, the terminal device 120-1 and the terminal device 120-2 can perform a sidelink transmission, which is also referred to as a device-to-device (D2D) communication, via a sidelink 125-1 between the terminal device 120-1 and the terminal device 120-2. For example, in the exemplary scenario of FIG. 1, the terminal device 120-1 is to perform a sidelink transmission 130-1 to the terminal device 120-2 via the sidelink 125-1. In some embodiments, the sidelink transmission 130-1 may be performed on unlicensed band in which various wireless devices based on different wireless technologies share the same wireless spectrum.

As shown in FIG. 1, the terminal devices 120-3 and 120-4 may be outside of the coverage range (namely, outside of the cell 112) of the network device 110. For the terminal devices 120-3 and 120-4, only destination selection in sidelink on unlicensed bands may exist. For example, the terminal device 120-1 and the terminal device 120-3 can perform a sidelink transmission via a sidelink 125-2 between the terminal device 120-1 and the terminal device 120-3. The terminal device 120-2 and the terminal device 120-4 can perform a sidelink transmission via a sidelink 125-3 between the terminal device 120-2 and the terminal device 120-4. The terminal device 120-3 and the terminal device 120-4 can perform a sidelink transmission via a sidelink 125-4 between the terminal device 120-3 and the terminal device 120-4. Although not shown in FIG. 1, sidelink transmissions may be performed between the terminal device 120-1 and the terminal device 120-4 and between the terminal device 120-2 and the terminal device 120-3 via respective sidelinks.

In some embodiments, the network device 110 may be absent in the communication environment 100. In other words, the terminal devices 120-1, 120-2, 120-3 and 120-4 as well as possibly other terminal devices (not shown) may be outside of the coverage range (namely, outside of the cell 112) of the network device 110. In such cases, only destination selection in sidelink on unlicensed bands may exist between the terminal devices 120-1, 120-2, 120-3, 120-4 and possibly other terminal devices not shown in FIG. 1.

As used herein, the term “sidelink transmission” generally refers to any transmission performed from one terminal device to another terminal device. The sidelink transmission may be used for transmitting any data or control information associated with destination selection in sidelink on unlicensed bands, for example, sidelink data, sidelink control information, sidelink feedback information, or the like. As used herein, the term “sidelink channel” may generally refer to any channel used for destination selection in sidelink on unlicensed bands, for example, Physical Sidelink Shared Channel (PSSCH), Physical Sidelink Control Channel (PSCCH), Physical Sidelink Discovery Channel (PSDCH), Physical Sidelink Broadcast Channel (PSBCH), Physical Sidelink Feedback Channel (PSFCH), and other existing or future sidelink channels.

Channel access in the sidelink can rely on the so-called LBT procedure. For example, before performing the sidelink transmission 130-1, the terminal device 120-1 can firstly “sense” a communication channel to find out that there are no communications on the communication channel prior to any transmission on the communication channel. If the sidelink transmission 130-1 is to be performed in an unlicensed band, the terminal device 120-1 may first perform a destination selection in sidelink on unlicensed band for the sidelink transmission 130-1. If a sidelink resource is scheduled or selected for the sidelink transmission 130-1, a LBT procedure may be performed prior to the sidelink transmission 130-1 on the scheduled or selected sidelink resource. In some embodiments, if a type-1 LBT procedure succeeds, the terminal device 120-1 may access the channel and perform the sidelink transmission 130-1 on the scheduled or selected sidelink resource. Furthermore, the terminal device 120-1 may occupy the channel for a COT.

In some embodiments, the sidelink transmission 130-1 may not require the entire duration of the COT. Thus, the terminal device 120-1 may allow another sidelink UE (e.g., the terminal devices 120-2, 120-3 and 120-4 as well as possibly other terminal devices (not shown)) to opportunistically join the COT and utilize any unoccupied resources. To facilitate COT sharing, the terminal device 120-1 may include COT sharing information in the SCI. For instance, the COT sharing information may include information associated with available or unoccupied resources, destination ID(s) and a priority (e.g., a CAPC priority) used for acquiring the COT.

In some embodiments, only those destinations with destination ID(s) in COT sharing information can be allowed to use the COT, and only those logical channels with a CAPC priority equal or higher than the CAPC priority in COT sharing information, can be selected to utilize the shared COT. For example, if the corresponding terminal device that obtains the COT sharing information is to perform a sidelink transmission and the destination ID of the sidelink transmission is included in the COT sharing information, the sidelink transmission may be performed in the COT initiated by the terminal device 120-1. In such events, the terminal device 120-1 initiating the COT may be referred to as “an initiating UE” and the terminal device performing the transmission using the shared COT may be referred to as “a responding UE”.

Although the network device 110 and the terminal devices 120-1, 120-2, 120-3 and 120-4 are described in the communication environment 100 of FIG. 1, embodiments of the present disclosure may equally apply to any other suitable communication devices in communication with one another. That is, embodiments of the present disclosure are not limited to the exemplary scenarios of FIG. 1. In this regard, it is noted that although the network device 110 is schematically depicted as a base station and the terminal devices 120 are schematically depicted as mobile phones in FIG. 1, it is understood that these depictions are exemplary in nature without suggesting any limitation. In other embodiments, the network device 110 and the terminal devices 120 may be any other communication devices, for example, any other wireless communication devices.

In case the terminal devices 120-1, 120-2, 120-3 and 120-4 are vehicle-mounted terminal devices, communication relate to them may be referred to as a V2X communication. More generally, although not shown in FIG. 1, the V2X communication related to the terminal devices 120 may comprise a communication channel between the terminal devices 120 and any other communication device, including but not limited to, an infrastructure device, another vehicle-mounted terminal device, a device of a pedestrian, a roadside unit, or the like. Furthermore, although not shown, all the communication links as shown in FIG. 1 may be via one or more relays.

It is to be understood that the particular number of various communication devices, the particular number of various communication links, the particular number of other elements, and the particular shape of the cell 112 as shown in FIG. 1 is for illustration purpose only without suggesting any limitations. The communication environment 100 may include any suitable number of communication devices, any suitable number of communication links, any suitable number of other elements and any suitable shape of the cell 112 adapted for implementing embodiments of the present disclosure. In addition, it should be appreciated that there may be various wireless as well as wireline communications (if needed) among all of the communication devices.

Communication in the communication environment 100 may be implemented according to any proper communication protocol(s), comprising but not limited to, cellular communication protocols of the first generation (1G), the second generation (2G), the third generation (3G), the fourth generation (4G) and the fifth generation (5G), NR-U and the like, wireless local network communication protocols such as Institute for Electrical and Electronics Engineers (IEEE) 802.11 and the like, and/or any other protocols currently known or to be developed in the future. Moreover, such communication may utilize any appropriate wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Example Method

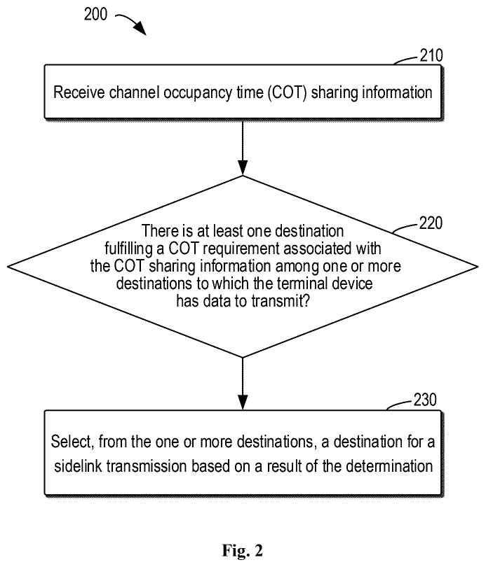

FIG. 2 illustrates a flowchart of an example method 200 for destination selection in accordance with some embodiments of the present disclosure. In some embodiments, the method 200 can be implemented at a device in a communication network, such as the terminal device 120-2 as shown in FIG. 1. Additionally or alternatively, the method 200 can be implemented at other devices shown in FIG. 1. In some other embodiments, the method 200 may be implemented at devices not shown in FIG. 1. Further, it is to be understood that the method 200 may include additional blocks not shown and/or may omit some blocks as shown, and the scope of the present disclosure is not limited in this regard. For the purpose of discussion, the method 200 will be described from the perspective of the terminal device 120-2 with reference to FIG. 1.

At block 210, the terminal device 120-2 receives channel occupancy time (COT) sharing information. At block 220, the terminal device 120-2 determines whether there is at least one destination fulfilling a COT requirement associated with the COT sharing information among one or more destinations to which the terminal device has data to transmit. At block 230, the terminal device 120-2 select, from the one or more destinations, a destination for a sidelink transmission based on a result of the determination. Thus, the reliability and efficiency of sidelink communication may be improved.

For example, with reference to FIG. 1, the terminal device 120-2 may perform multiplexing and assembly for MAC PDU. Since each MAC PDU can only be sent to one destination, the terminal device 120-2 may perform a LCP procedure during the multiplexing and assembly so as to select a target destination and corresponding logical channel(s) that will be multiplexed into the MAC PDU. During the destination selection, if there is no available COT sharing information, the terminal device 120-2 may follow a legacy procedure to select a destination, i.e., to select the destination according to 5.22.1.4.1.2 in TS 38.321. The existing destination selection conditions in 5.22.1.4.1.2 in TS 38.321 is as following:

| | |
|---|---|
| 4> | SL data for NR sidelink communication is available for transmission; and |
| 4> | SBj > 0, in case there is any logical channel having SBj > 0; and |
| 4> | sl-configuredGrantType1Allowed, if configured, is set to true in case the SL |
| | grant is a Configured Grant Type 1; and |
| 4> | sl-AllowedCG-List, if configured, includes the configured grant index |
| | associated to the SL grant; and |
| 4> | sl-HARQ-FeedbackEnabled is set to disabled, if PSFCH is not configured for |
| | the SL grant associated to the SCI. |

On the other hand, if there is available COT sharing information (e.g., COT sharing information received from the terminal device 120-1), the shared COT can be utilized by sidelink transmissions to destination(s) that fulfills a COT requirement associated with the COT sharing information among those destinations that can fulfil the existing destination selection conditions in 5.22.1.4.1.2 in TS 38.321. As used hereinafter, such destinations may be referred to as “COT allowed destinations”. The destinations that don't fulfill the COT requirement associated with the COT sharing information may be referred to as “COT unallowed destinations”. The shared COT cannot be utilized by sidelink transmissions to the COT unallowed destinations.

The terminal device 120-2 may determine whether there is at least one COT allowed destination and select the destination based on the determination result. For example, if there is at least one COT allowed destination and other conditions (if any) are fulfilled, the terminal device 120-2 may perform the destination selection based on the COT sharing information, i.e., perform a changed-LCP procedure to consider additional COT sharing restrictions in addition to the above existing destination selection conditions in 5.22.1.4.1.2 in TS 38.321. If there is no COT allowed destination and/or other conditions (if any) are not fulfilled, the terminal device 120-2 may perform the destination selection based on the legacy procedure, i.e., without considering additional COT sharing restrictions.

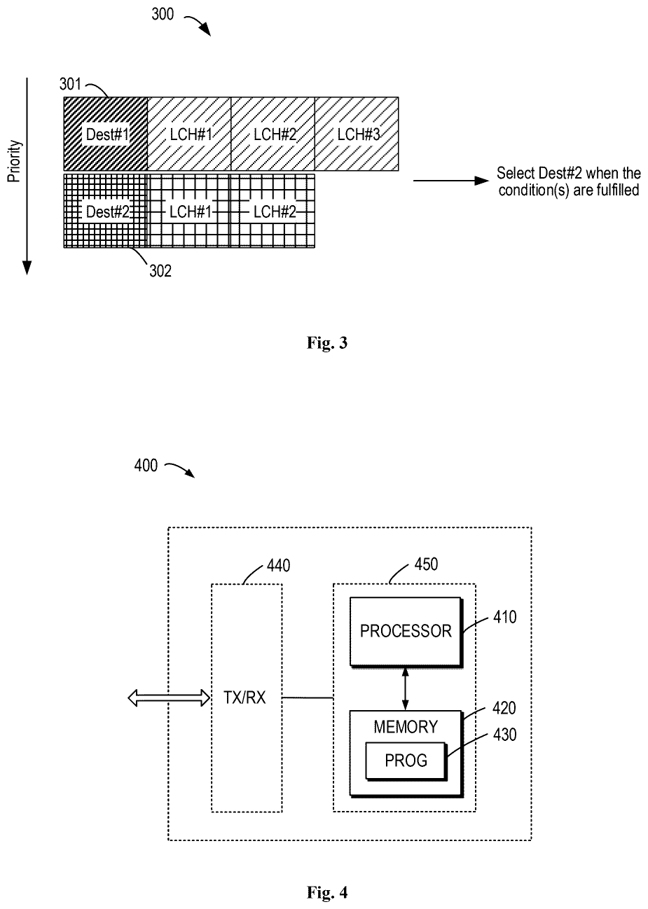

FIG. 3 illustrates an example block scheme for destination selection 300 in accordance with some embodiments of the present disclosure. For the purpose of discussion, the destination selection 300 will be described from the perspective of the terminal device 120-2 with reference to FIG. 1. As shown in FIG. 3, the terminal device 120-2 may have data in its buffer to transmit to multiple destinations, e.g., Dest #1 and Dest #2. Among these destinations, Dest #1 is not included in the destination ID(s) in the COT sharing information. Dest #2 is included in the destination ID(s) in the COT sharing information and has at least one logical channel with a CAPC priority equal to or higher than the CAPC priority in the COT sharing information. Thus, the Dest #1 may be determined as a COT unallowed destination and the Dest #2 may be determined as a COT allowed destination. The Dest #2 may thus be selectable if other conditions (if any) are fulfilled, e.g., if the highest priority of all logical channels that are associated with Dest #2 is higher than or equal to all logical channels that are associated with the destinations of the terminal device 120-2.

Hereinafter, some embodiments for conditions for considering/not considering additional COT sharing restrictions in will be described in detail below. Other embodiments are also possible.

In some embodiments, the terminal device 120-2 may select the destination based on the COT sharing information if there is the at least one destination fulfilling the COT requirement. In other words, the terminal device 120-2 may consider additional COT sharing restrictions in addition to the above existing destination selection conditions in 5.22.1.4.1.2 in TS 38.321 if there is available COT sharing information, and there is at least one COT allowed destination. Otherwise, the terminal device 120-2 may not consider additional COT sharing restrictions.

In some embodiments, there may be at least one destination that fulfills the COT requirement. The terminal device 120-2 may select the destination based on the COT sharing information if a condition associated with the at least one destination is fulfilled.

Embodiments of the condition associated with the at least one destination may be illustrated with reference to a specific implementation. For example, the COT sharing information may comprise destination ID(s) #1, #2, #3 and a CAPC priority of 2. In the buffers of the terminal device 120-2, there may be data to destinations with destination ID(s) #1, #2, #4 and #5. These destinations may correspond to the following logical channels (LCHs) with corresponding CAPC priorities and LCH priorities:
Destination ID #1: LCH #1 (CAPC=1, LCH priority=3), LCH #2 (CAPC=2, LCH priority=3), LCH #3 (CAPC=3, LCH priority=4);
Destination ID #2: LCH #1 (CAPC=1, LCH priority=4), LCH #2 (CAPC=1, LCH priority=3), LCH #3 (CAPC=2, LCH priority=4);
Destination ID #4: LCH #1 (CAPC=1, LCH priority=2), LCH #2 (CAPC=2, LCH priority=2), LCH #3 (CAPC=3, LCH priority=4);
Destination ID #5: LCH #1 (CAPC=1, LCH priority=3), LCH #2 (CAPC=2, LCH priority=3), LCH #3 (CAPC=3, LCH priority=4).

The destinations with destination IDs #1 and #2 meet the requirements that their destination IDs belong to the destination ID(s) in the COT sharing information and that they have logical channel(s) with a CAPC priority equal to or higher than the CAPC priority in the COT sharing information. Thus, the destinations with destination IDs #1 and #2 may be determined as a COT allowed destination and destinations with destination IDs #4 and #5 may be determined as COT unallowed destinations.

In some embodiments, the condition may comprise that a logical channel (LCH) among at least one LCH associated with the at least one destination has a highest LCH priority among one or more LCH priorities associated with the one or more destinations. In other words, the terminal device 120-2 may consider additional COT sharing restrictions in addition to the above existing destination selection conditions in 5.22.1.4.1.2 in TS 38.321 if there is available COT sharing information, there is at least one COT allowed destination, and there is no other destination that includes a higher priority logical channel than all the COT allowed destinations. Otherwise, the terminal device 120-2 may not consider additional COT sharing restrictions. For example, in the example implementation described above, the destination with destination ID #4 includes a logical channel LCH #1 with a LCH priority of 2 which is higher than all the logical channel priorities of the COT allowed destinations with destination IDs #1 and #2. Thus, the terminal device 120-2 may not consider additional COT sharing restrictions.

In some embodiments, a LCH priority associated with a remaining destination other than the at least one destination among the one or more destinations may be higher than a highest LCH priority among at least one LCH priority associated with the at least one destination. The condition may comprise that a highest LCH priority associated with the remaining destination is equal to or lower than a priority threshold. In other words, the terminal device 120-2 may consider additional COT sharing restrictions in addition to the above existing destination selection conditions in 5.22.1.4.1.2 in TS 38.321 if there is available COT sharing information, there is at least one COT allowed destination, there are one or more destinations that include a higher priority logical channel than all the COT allowed destinations, and the highest LCH priority of such destinations is not higher than a configured priority threshold. Otherwise, the terminal device 120-2 may not consider additional COT sharing restrictions. For example, in the example implementation described above, although the destination with destination ID #4 includes a logical channel LCH #1 with a LCH priority of 2 which is higher than all the logical channel priorities of the COT allowed destinations with destination IDs #1 and #2, its LCH channel priority is not higher than a configured priority threshold of 1. Thus, the terminal device 120-2 may consider additional COT sharing restrictions, i.e., performing the destination selection based on the COT sharing information.

In some embodiments, a LCH priority associated with a remaining destination other than the at least one destination among the one or more destinations may be higher than a highest LCH priority among at least one LCH priority associated with the at least one destination. The condition may comprise that a highest LCH priority associated with the remaining destination being not comprised in a priority list configured by an upper layer of the terminal device. In other words, the terminal device 120-2 may consider additional COT sharing restrictions in addition to the above existing destination selection conditions in 5.22.1.4.1.2 in TS 38.321 if there is available COT sharing information, there is at least one COT allowed destination, there are one or more destinations that include a higher priority logical channel than all the COT allowed destinations, and the highest LCH priority of such destinations is not included in higher layer configured priority list. Otherwise, the terminal device 120-2 may not consider additional COT sharing restrictions.

In some embodiments, a LCH priority associated with a remaining destination other than the at least one destination among the one or more destinations may be higher than a highest LCH priority among at least one LCH priority associated with the at least one destination. The condition may comprise that a minimum one among at least one remaining packet delay budget (PDB) of at least one LCH associated with the remaining destination being equal to or higher than a PDB threshold. In other words, the terminal device 120-2 may consider additional COT sharing restrictions in addition to the above existing destination selection conditions in 5.22.1.4.1.2 in TS 38.321 if there is available COT sharing information, there is at least one COT allowed destination, there are one or more destinations that include a higher priority logical channel than all the COT allowed destinations, and the minimum remaining PDB of such destination is not lower than a configured threshold. Otherwise, the terminal device 120-2 may not consider additional COT sharing restrictions. For example, in the example implementation described above, if the configured remaining PDB threshold is 20 ms and the remaining PDB of the destination with destination ID #4 is 40 ms which is not shorter than the configured remaining PDB threshold, the terminal device 120-2 may consider additional COT sharing restrictions, i.e., performing the destination selection based on the COT sharing information.

In some embodiments, a LCH priority associated with a remaining destination other than the at least one destination among the one or more destinations may be higher than a highest LCH priority among at least one LCH priority associated with the at least one destination. The condition may comprise that there being a sidelink shared channel resource in a minimum one among at least one remaining PDB of at least one LCH associated with the remaining destination. In other words, the terminal device 120-2 may consider additional COT sharing restrictions in addition to the above existing destination selection conditions in 5.22.1.4.1.2 in TS 38.321 if there is available COT sharing information, there is at least one COT allowed destination, there are one or more destinations that include a higher priority logical channel than all the COT allowed destinations, and there is a SL-SCH resource in the minimum remaining PDB of such destination. Otherwise, the terminal device 120-2 may not consider additional COT sharing restrictions. For example, in the example implementation described above, if there is a SL-SCH resource in the minimum remaining PDB of the destination with destination ID #4, the terminal device 120-2 may consider additional COT sharing restrictions, i.e., performing the destination selection based on the COT sharing information.

In some embodiments, a LCH priority associated with a remaining destination other than the at least one destination among the one or more destinations may be higher than a highest LCH priority among at least one LCH priority associated with the at least one destination. The condition may comprise that a size of a prioritized sidelink bucket of each of at least one LCH associated with the remaining destination being smaller than a size threshold. In other words, the terminal device 120-2 may consider additional COT sharing restrictions in addition to the above existing destination selection conditions in 5.22.1.4.1.2 in TS 38.321 if there is available COT sharing information, there is at least one COT allowed destination, there are one or more destinations that include a higher priority logical channel than all the COT allowed destinations, and SBj of any logical channel of such destination is smaller than sidelink bucket size. Otherwise, the terminal device 120-2 may not consider additional COT sharing restrictions.

In some embodiments, the condition may comprise that at least one medium access control (MAC) control element (CE) is to be transmitted to a remaining destination other than the at least one destination among the one or more destinations, and that the MAC CE has a higher priority than transmissions to the at least one destination. In other words, the terminal device 120-2 may consider additional COT sharing restrictions in addition to the above existing destination selection conditions in 5.22.1.4.1.2 in TS 38.321 if there is available COT sharing information, there is at least one COT allowed destination, and there are one or more destinations that include a higher priority MAC CE than all COT allowed destinations.

In some embodiments, the COT sharing information may be associated with multiple shared COTs. In other words, there may be multiple available COTs that can be utilized by the terminal device 120-2. For example the terminal device 120-2 may receive first COT sharing information from the terminal device 120-1, second COT sharing information from the terminal device 120-3, and third COT sharing information from the terminal device 120-4. Multiple COTs occupied by the terminal devices 120-1, 120-3 and 120-4 may be utilized by the terminal device 120-2. The terminal device 120-2 may determine a first set of COT allowed destinations corresponding to the first COT sharing information, a second set of COT allowed destinations corresponding to the second COT sharing information and a third set of COT allowed destinations corresponding to the third COT sharing information.

In some embodiments, when selecting the destination based on the COT sharing information, the terminal device 120-2 may select, from the one or more destinations, the destination associated with a highest LCH priority among one or more LCH priorities associated with the one or more destinations. In other words, if the terminal device 120-2 determines to perform LCP considering additional COT sharing restrictions besides existing destination selection conditions in 5.22.1.4.1.2 in TS 38.321, the terminal device 120-2 may select a destination with the highest LCH priority among all COT allowed destinations.

In some embodiments, when selecting the destination based on the COT sharing information, the terminal device 120-2 may select, from the one or more destinations, the destination fulfilling a COT requirement associated with a shared COT among the multiple shared COTs if a remaining duration of the shared COT is shorter than a duration threshold. In other words, if the terminal device 120-2 determines to perform LCP considering additional COT sharing restrictions besides existing destination selection conditions in 5.22.1.4.1.2 in TS 38.321, the terminal device 120-2 may prioritize to select, among all COT allowed destinations, a destination if the remaining shared COT duration of a COT corresponding to the destination is lower than a remaining COT threshold.

Another specific aspect of destination selection for sidelink transmissions is the assistance information from the responding UE to facilitate the initiating UE to share the COT. In addition to transmission to the initiating UE using the shared COT, the responding UE may also transmit to broadcast destinations or groupcast destinations. The initiating UE may be a potential receiver for the broadcast or groupcast transmission. The initiating UE may always include the destinations that it is interested in into the allowed destination ID list in the COT sharing information, but such solution might cost a lot of signaling.

In some embodiments, the responding UE may transmit assistance information to the initiating UE, indicating that the destination IDs for broadcast and groupcast to which it has data to transmit. For example, the responding UE may transmit assistance information to the initiating UE, to assist the initiating UE to better share its COT so as to increase the utilization probability of the responding UE. For example, the responding UE may transmit, to the initiating UE, a destination ID list of the responding UE for transmission. If one or more destination IDs are also the receiving destination of initiating UE, the initiating UE may include these destination ID(s) into the COT sharing information so that the responding UE can use the shared COT of the initiating UE to transmit data to these destinations.

In some embodiments, the terminal device may be a first terminal device. The terminal device may transmit, to a second terminal device, assistant information for COT sharing via PC5 radio resource control (RRC) signaling. For example, the terminal device 120-2 as the responding UE may transmit assistance information for COT sharing to the terminal device 120-1 via PC5 RRC signaling, e.g. a UEAssistanceInformationSidelink message. The UEAssistanceInformationSidelink message may be used to transmit SL-DRX assistance information. In some embodiments, the UEAssistanceInformationSidelink message may also carry assistance information for COT sharing.

In some embodiments, the assistant information may comprise at least one of a destination identifier list or a traffic pattern of the first terminal device. In some embodiments, the PC5 RRC signaling may comprise at least one index of at least one destination identifier in the destination identifier list. In other words, besides destination ID(s) (for transmission) of the responding UE, the traffic pattern, which includes traffic periodicity and start offset, may also be included in the assistance information for COT sharing.

In some embodiments, the PC5 RRC signaling may be triggered based on an establishment of a unicast connection between the first terminal device (e.g., the responding UE) and the second terminal device (e.g., the initiating UE). In some embodiments, the PC5 RRC signaling may be triggered based on a capability exchange between the first terminal device (e.g., the responding UE) and the second terminal device (e.g., the initiating UE). In some embodiments, the PC5 RRC signaling may be triggered based on a PC5 RRC reconfiguration exchange between the (e.g., the responding UE) and the second terminal device (e.g., the initiating UE). In some embodiments, the PC5 RRC signaling may be triggered based on an establishment of a sidelink data radio bearer (SL-DRB). In some embodiments, the PC5 RRC signaling may be triggered based on an update of a SL-DRB. In some embodiments, the PC5 RRC signaling may be triggered based on a release of a SL-DRB. In some embodiments, the PC5 RRC signaling may be triggered based on an update of a destination identifier list of the first terminal device (e.g., the responding UE). If the assistance information for COT sharing is initiated, the responding UE may transmit the assistance information to the initiating UE. After the initiating UE receives the assistance information for COT sharing from its peer UE, the initiating UE may report COT sharing assistance information to the eNB or gNB if it is in a RRC_CONNECTED mode or in a resource allocation mode 1 (i.e., a dynamic scheduling mode).

In some embodiments, the terminal device may be a first terminal device. The terminal device may transmit, to a second terminal device, assistant information for COT sharing in a MAC CE. The assistance information may comprise an indication of a destination to which the terminal device has data to transmit. For example, besides the RRC signaling, a MAC CE can be transmitted to indicate the destination ID of the responding UE more dynamically. More specifically, the MAC CE may indicate those destination IDs that have data in the buffer of the first terminal device for transmission.

In some embodiments, the MAC CE may comprise a bitmap with a value for an index of a destination identifier of the first terminal device. A first value in the bitmap for the index may be indicative of existence of data to be transmitted to a destination associated with the index. A second value in the bitmap for the index may be indicative of no data to be transmitted to a destination associated with the index. For example, a bitmap may be designed to indicate the index of destination id, e.g. value “1” may be set for a specific destination ID if there is data for the destination ID, and value “0” may be set for a specific destination id if there is no data for the destination ID. The number of indicated destination ID(s) may equal to the number of destination IDs in the assistance information in the RRC signaling. The index of destination ID may be the index of destination ID in the destination ID list of RRC signaling.

In some embodiments, the MAC CE may be triggered if data arrives at a buffer of the first terminal device for a destination and there was no data in the buffer prior to the arrival of the data. In some embodiments, the MAC CE may be triggered if all data in a buffer of the first terminal device for a destination has been transmitted, i.e., data in the buffer has been cleared.

In some embodiments, the MAC CE may be cancelled if a buffer of the first terminal device for a destination is changed from first status back to second status indicated in a previous MAC CE transmitted by the first terminal device to the second terminal device before the MAC CE is transmitted. In other words, the buffer status of destination ID(s), i.e. whether there is data in the buffer for transmission, is changed back/unchanged compared with last reported MAC CE.

### Example Apparatus

FIG. 4 illustrates a simplified block diagram of a device 400 that is suitable for implementing embodiments of the present disclosure. The device 400 can be considered as a further example implementation of the terminal device 120 as shown in FIG. 1.

As shown, the device 400 includes a processor 410, a memory 420 coupled to the processor 410, a suitable transmitter (TX) and receiver (RX) 440 coupled to the processor 410, and a communication interface coupled to the TX/RX 440. The memory 410 stores at least a part of a program 430. The TX/RX 440 is for bidirectional communications. The TX/RX 440 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 430 is assumed to include program instructions that, when executed by the associated processor 410, enable the device 400 to operate in accordance with the embodiments of the present disclosure, as discussed herein with reference to FIGS. 1-6. The embodiments herein may be implemented by computer software executable by the processor 410 of the device 400, or by hardware, or by a combination of software and hardware. The processor 410 may be configured to implement various embodiments of the present disclosure. Furthermore, a combination of the processor 410 and memory 420 may form processing means 440 adapted to implement various embodiments of the present disclosure.

The memory 420 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 420 is shown in the device 400, there may be several physically distinct memory modules in the device 400. The processor 410 may be of any type suitable to the local technical network, and may include one or more of general purpose computers, special purpose computers, microprocessors, digital signal processors (DSPs) and processors based on multicore processor architecture, as non-limiting examples. The device 400 may have multiple processors, such as an application specific integrated circuit chip that is slaved in time to a clock which synchronizes the main processor.

In some embodiments, an apparatus capable of performing the method 200 (for example, the terminal device 120-2) may comprise means for performing the respective steps of the method 200. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 200.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

The embodiments of the present disclosure may further be described using the following clauses.
Clause 1. A terminal device comprising: a processor; and a transceiver coupled to the processor, wherein the processor is configured to: receive, via the transceiver, channel occupancy time (COT) sharing information; determine whether there is at least one destination fulfilling a COT requirement associated with the COT sharing information among one or more destinations to which the terminal device has data to transmit; and select, from the one or more destinations, a destination for a sidelink transmission based on a result of the determination.
Clause 2. The terminal device of clause 1, wherein selecting the destination comprises: selecting the destination based on the COT sharing information in the case that there is the at least one destination fulfilling the COT requirement.
Clause 3. The terminal device of clause 1, wherein there is the at least one destination fulfilling the COT requirement, and selecting the destination comprises: selecting the destination based on the COT sharing information in the case that a condition associated with the at least one destination is fulfilled.
Clause 4. The terminal device of clause 3, wherein the condition comprises: a logical channel (LCH) among at least one LCH associated with the at least one destination having a highest LCH priority among one or more LCH priorities associated with the one or more destinations.
Clause 5. The terminal device of clause 3, wherein a LCH priority associated with a remaining destination other than the at least one destination among the one or more destinations is higher than a highest LCH priority among at least one LCH priority associated with the at least one destination, and wherein the condition comprises one of the following:
a highest LCH priority associated with the remaining destination being equal to or lower than a priority threshold;
a highest LCH priority associated with the remaining destination being not comprised in a priority list configured by an upper layer of the terminal device;
a minimum one among at least one remaining packet delay budget (PDB) of at least one LCH associated with the remaining destination being equal to or higher than a PDB threshold;
there being a sidelink shared channel resource in a minimum one among at least one remaining PDB of at least one LCH associated with the remaining destination; or
a size of a prioritized sidelink bucket of each of at least one LCH associated with the remaining destination being smaller than a size threshold.
Clause 6. The terminal device of clause 3, wherein the condition comprises: at least one medium access control (MAC) control element (CE) being to be transmitted to a remaining destination other than the at least one destination among the one or more destinations, and the MAC CE having a higher priority than transmissions to the at least one destination.
Clause 7. The terminal device of clause 2 or 3, wherein the COT sharing information is associated with multiple shared COTs.
Clause 8. The terminal device of clause 7, wherein selecting the destination based on the COT sharing information comprises one of the following: selecting, from the one or more destinations, the destination associated with a highest LCH priority among one or more LCH priorities associated with the one or more destinations; or selecting, from the one or more destinations, the destination fulfilling a COT requirement associated with a shared COT among the multiple shared COTs in the case that a remaining duration of the shared COT is shorter than a duration threshold.
Clause 9. The terminal device of clause 1, wherein the terminal device is a first terminal device, and wherein the processor is further configured to: transmit, to a second terminal device, assistant information for COT sharing via PC5 radio resource control (RRC) signaling.
Clause 10. The terminal device of clause 9, wherein the assistant information comprises at least one of a destination identifier list or a traffic pattern of the first terminal device.
Clause 11. The terminal device of clause 10, wherein the PC5 RRC signaling comprises at least one index of at least one destination identifier in the destination identifier list.
Clause 12. The terminal device of clause 9, wherein the PC5 RRC signaling is triggered based on one of the following: an establishment of a unicast connection between the first terminal device and the second terminal device; a capability exchange between the first terminal device and the second terminal device; a PC5 RRC reconfiguration exchange between the first terminal device and the second terminal device; an establishment of a sidelink data radio bearer (SL-DRB); an update of a SL-DRB; a release of a SL-DRB; or an update of a destination identifier list of the first terminal device.
Clause 13. The terminal device of clause 1, wherein the terminal device is a first terminal device, and wherein the processor is further configured to: transmit, to a second terminal device, assistant information for COT sharing in a MAC CE, wherein the assistance information comprises an indication of a destination to which the terminal device has data to transmit.
Clause 14. The terminal device of clause 13, wherein the MAC CE comprises a bitmap with a value for an index of a destination identifier of the first terminal device, and wherein a first value in the bitmap for the index is indicative of existence of data to be transmitted to a destination associated with the index, and a second value in the bitmap for the index is indicative of no data to be transmitted to a destination associated with the index.
Clause 15. The terminal device of clause 13, wherein the MAC CE is triggered based on one of the following: data arriving at a buffer of the first terminal device for a destination and no data being in the buffer prior to the arrival of the data; or all data in a buffer of the first terminal device for a destination being transmitted.
Clause 16. The terminal device of clause 13, wherein the MAC CE is cancelled based on: before the MAC CE is transmitted, a buffer of the first terminal device for a destination being changed from first status back to second status indicated in a previous MAC CE transmitted by the first terminal device to the second terminal device.
Clause 17. A method performed by a terminal device, comprising: receiving channel occupancy time (COT) sharing information; determining whether there is at least one destination fulfilling a COT requirement associated with the COT sharing information among one or more destinations to which the terminal device has data to transmit; and selecting, from the one or more destinations, a destination for a sidelink transmission based on a result of the determination.
Clause 18. A non-transitory computer readable medium having program instructions stored thereon that, when executed by an apparatus, cause the apparatus at least to: receive channel occupancy time (COT) sharing information; determine whether there is at least one destination fulfilling a COT requirement associated with the COT sharing information among one or more destinations to which the terminal device has data to transmit; and select, from the one or more destinations, a destination for a sidelink transmission based on a result of the determination.

1. A terminal device for wireless communication, comprising:
at least one memory; and
at least one processor coupled with the at least one memory and configured to cause the terminal device to:
receive channel occupancy time (COT) sharing information;
determine whether there is at least one destination fulfilling a COT requirement associated with the COT sharing information among one or more destinations to which the terminal device has data to transmit; and
select, from the one or more destinations, a destination for a sidelink transmission based on a result of the determination.

2. The terminal device of claim 1, wherein, to select the destination, the at least one processor is configured to cause the terminal device to:
select the destination based on the COT sharing information when there is the at least one destination fulfilling the COT requirement.

3. The terminal device of claim 1, wherein, when there is the at least one destination fulfilling the COT requirement, the least one processor is configured to cause the terminal device to select the destination by:
selecting the destination based on the COT sharing information when a condition associated with the at least one destination is fulfilled.

4. The terminal device of claim 3, wherein the condition comprises:
a logical channel (LCH) among at least one LCH associated with the at least one destination having a highest LCH priority among one or more LCH priorities associated with the one or more destinations.

5. The terminal device of claim 4, wherein a LCH priority associated with a remaining destination other than the at least one destination among the one or more destinations is higher than a highest LCH priority among at least one LCH priority associated with the at least one destination, and wherein the condition comprises:
a highest LCH priority associated with the remaining destination being equal to or lower than a priority threshold;
a highest LCH priority associated with the remaining destination being not comprised in a priority list configured by an upper layer of the terminal device;
a minimum one among at least one remaining packet delay budget (PDB) of at least one LCH associated with the remaining destination being equal to or higher than a PDB threshold;
there being a sidelink shared channel resource in a minimum one among at least one remaining PDB of at least one LCH associated with the remaining destination; or
a size of a prioritized sidelink bucket of each of at least one LCH associated with the remaining destination being smaller than a size threshold.

6. The terminal device of claim 1, wherein the terminal device is a first terminal device, and wherein the at least one processor is further configured to cause the terminal device to:
transmit, to a second terminal device, assistance information for COT sharing via PC5 radio resource control (RRC) signaling.

7. The terminal device of claim 6, wherein the assistance information comprises at least one of a destination identifier list or a traffic pattern of the first terminal device.

8. The terminal device of claim 7, wherein the PC5 RRC signaling comprises at least one index of at least one destination identifier in the destination identifier list.

9. The terminal device of claim 6, wherein the PC5 RRC signaling is triggered based on one of the following:
an establishment of a unicast connection between the first terminal device and the second terminal device;
a capability exchange between the first terminal device and the second terminal device;
a PC5 RRC reconfiguration exchange between the first terminal device and the second terminal device;
an establishment of a sidelink data radio bearer (SL-DRB);
an update of a SL-DRB;
a release of a SL-DRB; or
an update of a destination identifier list of the first terminal device.

10. The terminal device of claim 1, wherein the terminal device is a first terminal device, and wherein the at least one processor is further configured to cause the terminal device to:
transmit, to a second terminal device, assistance information for COT sharing in a media access control control element (MAC CE), wherein the assistance information comprises an indication of a destination to which the terminal device has data to transmit.

11. The terminal device of claim 10, wherein the MAC CE comprises a bitmap with a value for an index of a destination identifier of the first terminal device, and
wherein a first value in the bitmap for the index is indicative of existence of data to be transmitted to a destination associated with the index, and a second value in the bitmap for the index is indicative of no data to be transmitted to a destination associated with the index.

12. The terminal device of claim 10, wherein the MAC CE is triggered based on one of the following:
data arriving at a buffer of the first terminal device for a destination and no data being in the buffer prior to the arrival of the data; or
all data in a buffer of the first terminal device for a destination being transmitted.

13. The terminal device of claim 10, wherein the MAC CE is canceled based on:
before the MAC CE is transmitted, a buffer of the first terminal device for a destination being changed from a first status back to a second status indicated in a previous MAC CE transmitted by the first terminal device to the second terminal device.

14. A method performed by a terminal device, the method comprising:
receiving channel occupancy time (COT) sharing information;
determining whether there is at least one destination fulfilling a COT requirement associated with the COT sharing information among one or more destinations to which the terminal device has data to transmit; and
selecting, from the one or more destinations, a destination for a sidelink transmission based on a result of the determination.

15. (canceled)

16. The method of claim 14, wherein selecting the destination includes:
selecting the destination based on the COT sharing information when there is the at least one destination fulfilling the COT requirement.

17. The method of claim 14, wherein, when there is the at least one destination fulfilling the COT requirement, selecting the destination includes:
selecting the destination based on the COT sharing information when a condition associated with the at least one destination is fulfilled.

18. The method of claim 14, wherein the terminal device is a first terminal device, further comprising:
transmitting, to a second terminal device, assistance information for COT sharing via PC5 radio resource control (RRC) signaling.

19. The method of claim 18, wherein the assistance information comprises at least one of a destination identifier list or a traffic pattern of the first terminal device.

20. The method of claim 19, wherein the PC5 RRC signaling comprises at least one index of at least one destination identifier in the destination identifier list.

21. A user equipment (UE) for wireless communication, comprising:
at least one memory; and
at least one processor coupled with the at least one memory and configured to cause the UE to:
receive channel occupancy time (COT) sharing information;
determine whether there is at least one destination fulfilling a COT requirement associated with the COT sharing information among one or more destinations to which the terminal device has data to transmit; and
select, from the one or more destinations, a destination for a sidelink transmission based on a result of the determination.
